(19) United States
(12) Patent Application Publication
(10) Pub. No.: US 2019/0081426 A1
(43) Pub. Date: Mar. 14, 2019

(54) Multi-use Connector

(71) Applicant: Anand Kumar Chavakula, College Park, MD (US)

(72) Inventor: Anand Kumar Chavakula, College Park, MD (US)

(21) Appl. No.: 15/703,861

(22) Filed: Sep. 13, 2017

(51) Int. Cl. H01R 13/40; H01R 24/60; H01R 24/58; H01R 13/70; H01R 13/66; H01R 29/00

(52) U.S. Cl. CPC H01R 13/40; H01R 24/60; H01R 29/00; H01R 13/70; H01R 13/6691; H01R 24/58

(57) ABSTRACT

The Multi-use Connector in brief enables wired and wireless interconnection between a wide range of devices with a variety of input and output terminals. The usages of this invention can range in application between audio and electrical charging, and backup charging. Further, this invention has circuitry that can enable the conversion of analog audio signals from an analog source to digital signals for further wireless transmission through an onboard wireless transmission system, or convert digital signals received wirelessly to analog audio signals for further usage as maybe needed. Also, a companion software application to the Multi-use Connector can be used on smartphone like electronic devices that can allow the reception and recording of digital audio and or video signals transmitted by the Multi-use Connector, and also over-the-air analog sound signals received by a smartphone's inbuilt microphone system i.e., both signals can be recorded into separate channels at the same time.

### CROSS-REFERENCE TO RELATED APPLICATIONS

Not Applicable or The present application relates and claims priority to U.S. provisional patent application No. 62/493,632 filed on Jul. 12, 2016.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to a multi-use connector that enables wired and wireless interconnection between a wide range of devices with a variety of input and output terminals.

### Description of the Related Art

In the field of audio and charging, there are many different types of connectors to help with interconnecting various devices to facilitate transmitting and receiving sound for various audio application purposes, or electrical signals to charge a target mobile device. There are also many types of multi-use adapters or connectors to help with connecting from one type of source or device to another device or source. The current invention deals specifically with a certain multi use adapter which will now be referred to as the “Multi-use Connector” that can receive and transmit audio signals, wired and or wirelessly, and with a similar design transmit electrical signals to enable charging between a wide varieties of devices. This device has different sizes of input and output ports for audio transmission or electrical charging. The male plugs are typically connected to the main body through a swivel or pivot type of mechanism though this is not a limitation. The male and female connectors are cross connected in a way as maybe required so that the Multi-use Connector can enable cross connecting from one size to another thus enabling a wide variety of adapting from one type of connector to a completely different type of connector, or from one type of input connector to a different type of output connector or port.

The Multi-use Connector in the present invention also has other switches on the main body to enable different uses. In the audio configuration setting for example, it has a 3 to 4pin change switch, a stereo to mono switch, and an audio mute and unmute switch. Wireless connectivity: Other configurations for this type of Multi-use Connector are that it can have the ability to convert analog audio signals typically coming from a headphone port of a musical instrument for example into digital signals and those signals can be transmitted wirelessly through a Bluetooth like feature or system built into the present invention, to another Multi-use Connector and or to a compatible software application that can work with this invention. To enable these features, power is needed; therefore, there will be an inbuilt battery that is rechargeable and removable. This way, any device like a music keyboard or smartphone or a computer like device which may have an audio output port can be enabled to transmit wireless digital audio signals.

The removable and rechargeable battery located inside the unit can be recharged through the USB male connector of the Multi-use Connector which can then be connected to an AC converter plug or a computer's USB port to charge the battery inside as needed from time to time.

There will also be a pairing switch on the Multi-use Connector to connect to another similar device. One MUC can be in a receive mode while another can be put in a send mode.

Software Application connectivity: As an added feature, a software application or “app” as it is popularly known can be made to function through a Smartphone, tablet or desktop like computers to receive the wireless audio signals being transmitted by the Multi-use Connector to get those wireless signals recorded in an audio recording like application. The unique feature of the Multi-use Connector is that it can record wirelessly received digital signals, and also analog sound signals received over the air through an inbuilt microphone of a smartphone device. An example of this use can be that if a Multi-use Connector is connected by its ⅛″ or ¼″ male plug to an electronic music instrument like a keyboard's headphone outlet, the musical instrument's analog audio signals can then be converted by the Multi-use Connector to wirelessly transmit, and these wireless audio or data signals can be detected and received by the Multi-use Connector's Software Application to be further recorded or processed as the user may decide.

While the Multi-use Connector has a built-in wireless feature to transmit audio signals from a connected electronic instrument or any device, a user can also connect headphones to the corresponding female inputs of the Multi-use Connector and also be able to hear or monitor the same signals being transmitted wirelessly from the electronic music keyboard or device. Further, there will be a switch on the Multi-use Connector to enable or disable wireless signal transmission or reception.

Charger Configuration: This same design that is used to transmit audio from one style of port to another, can also be used to conduct an electrical charge to various mobile devices by converting one style of plug to another. For example, a micro USB connector can be converted to a Lightning connector made by Apple, Inc. and vice a versa. The way this is achieved is that at the base of the connector unit, there will be both a Micro USB female socket or input port, and also a Lightning Connector female socket or port though this is not intended to be a limitation, and the male counterpart of both the Micro USB connector and also the Lightning Connector will be located, connected in a pivot like mechanism on the opposite side of the said device. This configuration has a converter circuitry inside the unit to convert from one style of charger to another.

Another charging configuration can be that on the base side, there can be two or three regular sized USB female ports and then on the other end, an AC plug, a DC plug and also a regular size USB male plug. Further, the AC plug will have circuitry to enable automatic voltage selection switching between 220v and 120v as an example.

Battery charger and converter configuration: This same design can be configured to have a rechargeable battery inside the MUC which gets charged whenever it is connected to an AC or DC power source. The Multi-use Connector in this way can itself be charged because of the rechargeable battery inside the unit, and this battery in turn can be used for emergency charging of a mobile device it may be connected to.

### BRIEF SUMMARY OF THE INVENTION

This invention concerns a new and improved Multi-use Connector that enables wired and wireless interconnection between a wide range of devices with a variety of input and output terminals. The usages of this invention can range in application between audio and electrical charging, and backup charging.

In another aspect, the invention has circuitry that can enable the conversion of analog audio signals from an analog source to digital signals for further wireless transmission through an onboard wireless transmission system, or convert digital signals received wirelessly to analog audio signals for further usage as maybe needed.

### DESCRIPTION OF THE DRAWINGS

For a more complete understanding of the present invention, reference is now made to the following descriptions:

FIG. 1 Triple size female to male Headphone, 3pin to 4pin, stereo to mono, mute and unmute audio adapter.

FIG. 2 Triple size female to male Headphone, 3pin to 4pin, stereo to mono, mute and unmute audio adapter.

FIG. 3 Triple size female to male Headphone, 3pin to 4pin, stereo to mono, mute and unmute audio adapter.

FIG. 4 Triple size female to male Headphone, 3pin to 4pin, stereo to mono, mute and unmute audio adapter.

FIG. 5 Triple size female to male Headphone, 3pin to 4pin, stereo to mono, mute and unmute audio adapter.

FIG. 6 Dual size, Quadruple input female to male Headphone stereo audio adapter.

FIG. 7 Wired and Wireless, Dual size, Quadruple input female to male Headphone stereo audio adapter.

FIG. 8 Wired and Wireless, Dual size, Quadruple input female to male Headphone stereo audio adapter.

FIG. 9 Wired and Wireless, Dual size, Quadruple input female to male Headphone stereo audio adapter. Shown in the figure is the logic to show the method in a circuit board to convert analog audio signals to digital and digital audio signals to analog as needed.

FIG. 10 Wired and Wireless, Dual size, Quadruple input female to male Headphone stereo audio adapter. Shown in the figure is the logic to show the method in a circuit board to convert digital audio signals to analog.

FIG. 11 Wired and Wireless, Dual size, Quadruple input female to male Headphone stereo audio adapter.

FIG. 12 Wired and Wireless, Dual size, Quadruple input female to male Headphone stereo audio adapter. With a TV(19) and a wireless signal recording app.

FIG. 13 Software Application that supports the recording of both wireless audio or video signals coming through a wireless transmitter like the Multi-use Connector and simultaneously recording over-the-air audio signals through a smartphone's microphone in two or more separate channels.

FIG. 14 Multi-use Connector Dual Charger plug converter.

FIG. 15 Multi-use Connector Dual Charger plug converter.

FIG. 16 Multi-use Connector Triple Charger plug converter.

FIG. 17 Multi-use Connector Triple Charger plug converter.

FIG. 18 Multi-use Connector AC/DC/USB Connector.

FIG. 19 Multi-use Connector AC/DC/USB Connector.

FIG. 20 Multi-use Connector AC/DC/USB Connector.

FIG. 21 Multi-use Connector Backup charger and Dual Charger plug converter.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

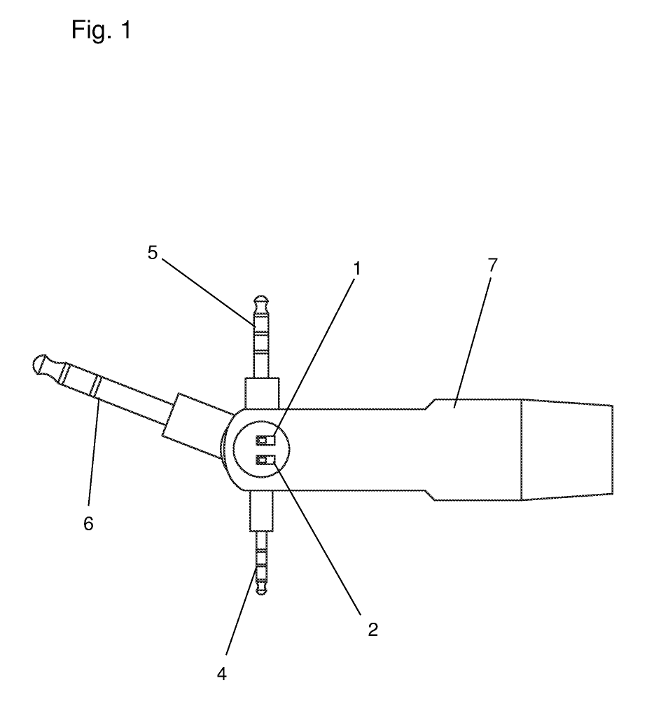

FIG. 1 through FIG. 5 illustrate the Multi-use Connector showing in the configuration of a triple sized female to male headphone adapter with the following features:

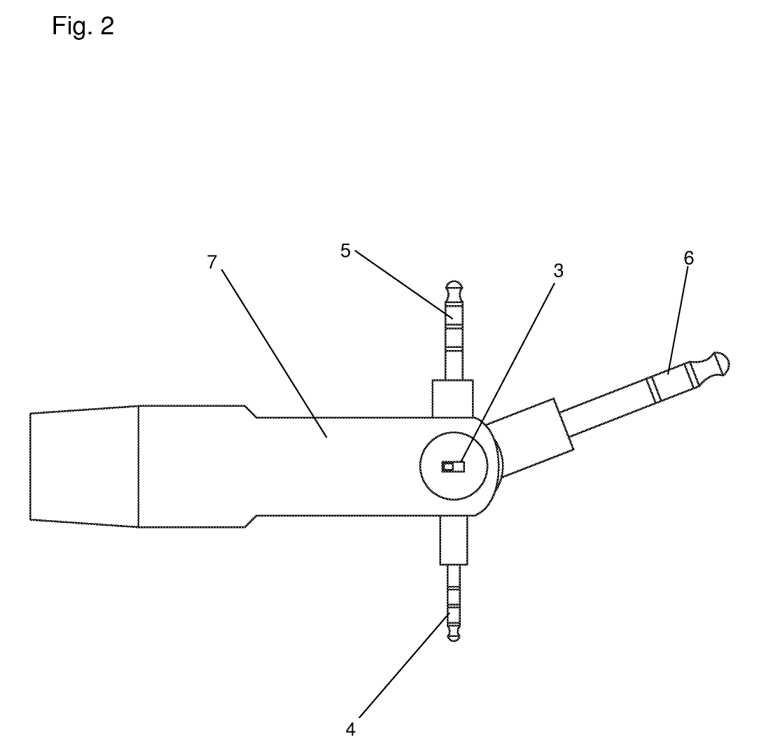

FIG. 1 shows the convert switch 1 on the main body that will have the ability to change from a 3 pin position to a 4 pin and back, the stereo/mono switch 2 to change from a stereo signal to a mono signal and back, and the mute switch 3 as shown in FIG. 2 to mute and unmute the audio signals.

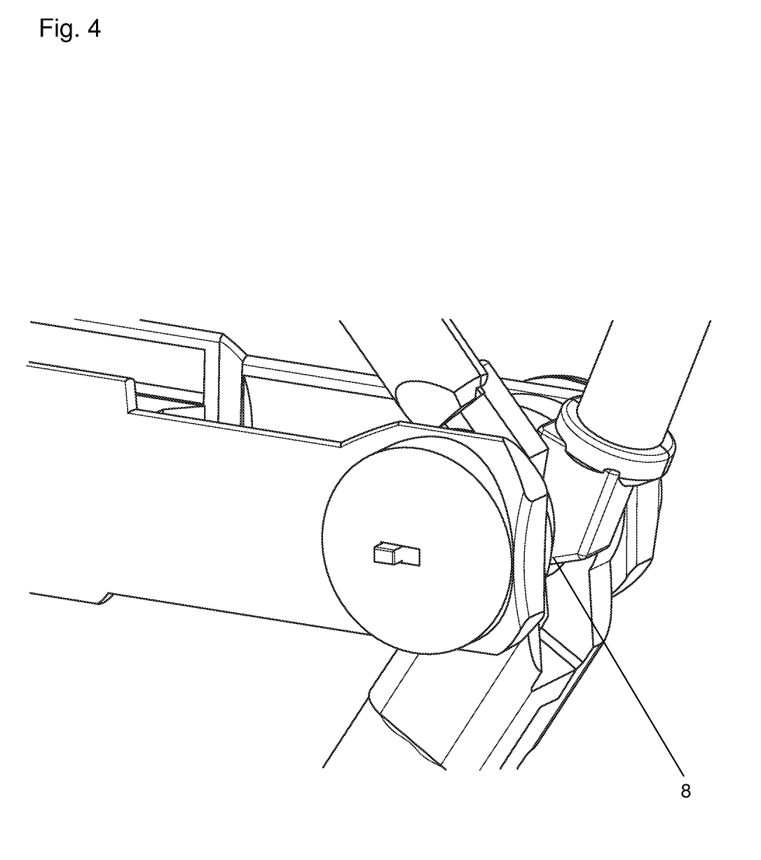

Further, FIG. 1 and FIG. 2 shows a male stereo 3/32″ size audio plug 4, and a male stereo ⅛″ size audio plug 5, and a male stereo ¼″ audio plug 6, and all the male plugs connected to the main body 7 through a pivot or swivel style method by a hinge 8 as also shown in FIG. 4.

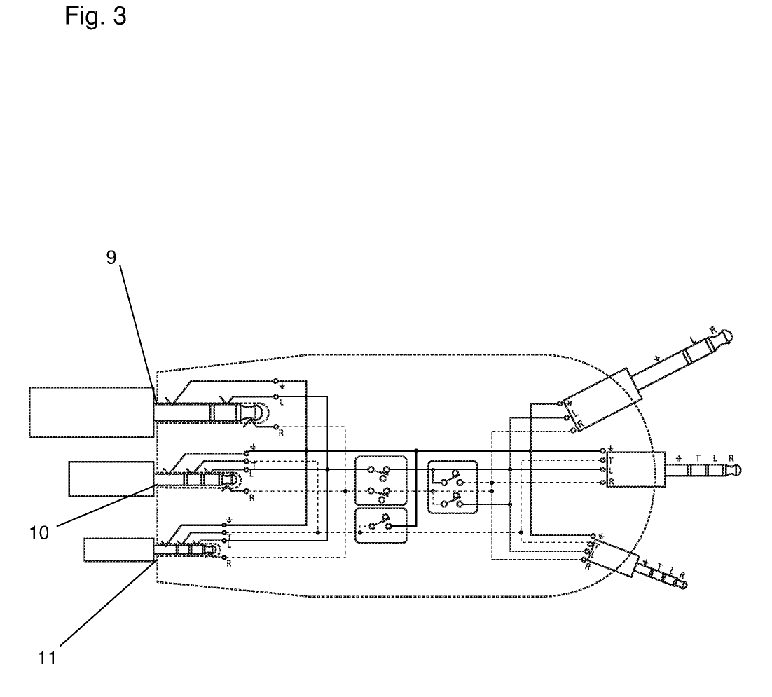

FIG. 3 shows the inside circuit which illustrates a cross connection to connect all the various male and female ports to enable cross connection of all the inputs and outputs. Also shown are stereo female ports of various sizes like: a stereo female ¼″ 8 size port 9, a stereo female ⅛″ 9 size port 10 and a stereo female 3/32″ size port 11.

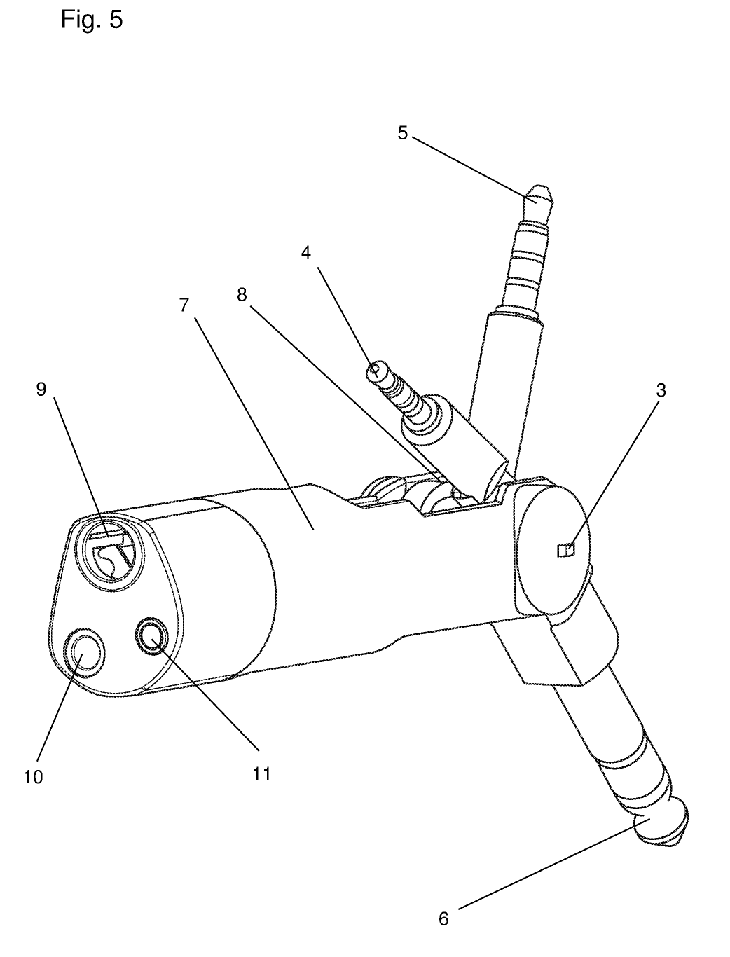

FIG. 5 shows a cross view of the invention shows a male stereo 3/32″ size audio plug 4, and a male stereo ⅛″ size audio plug 5, and a male stereo ¼″ audio plug 6, and all the male plugs connected to the main body 7 through a pivot or swivel style method by a hinge 8, also the FIG. 5 shows a stereo female ¼″ 8 size port 9, a stereo female ⅛″ 9 size port 10 and a stereo female 3/32″ size port 11, also it is shows the mute switch 3.

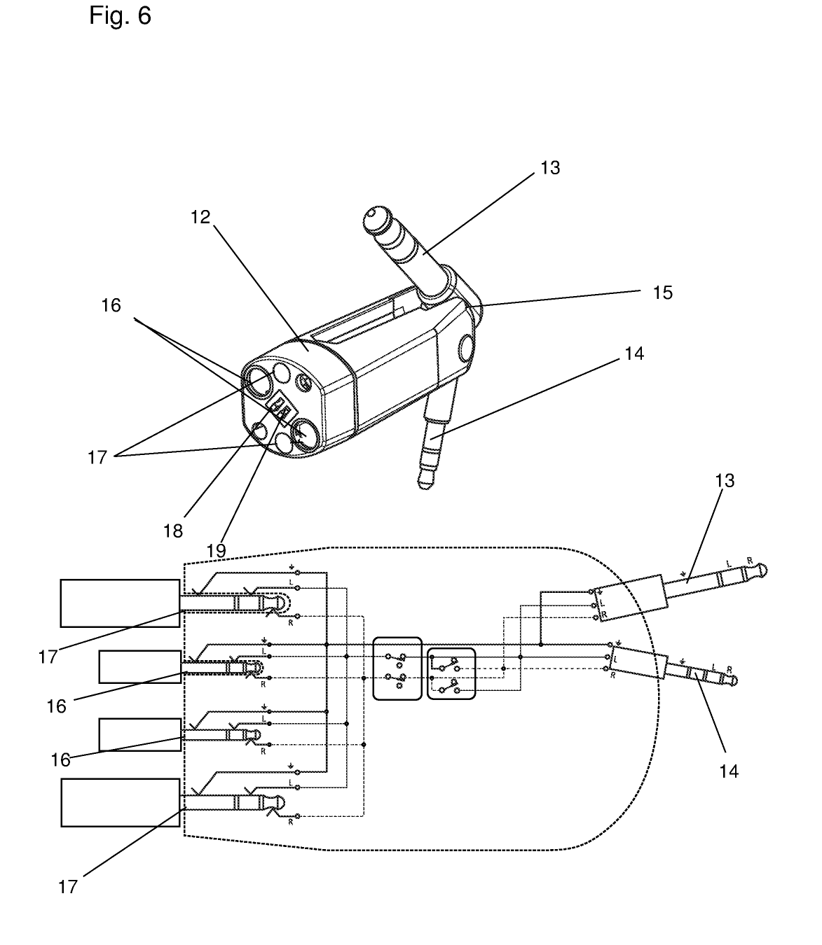

FIG. 6 illustrates a view of the Multi-use Connector showing in the configuration of a “Dual size, Quadruple input female to male headphone stereo audio adapter.” Shown are various features like a cross section view of the outer body of the invention 12, and an inside circuit that shows the cross connection of all the various terminals. Shown in FIG. 6 are for example: ¼″ male stereo audio plug 13 and ⅛″ male stereo audio plug 14 connected through a pivot or swivel style method by a hinge 15 to the main body 12, and two ¼″ female stereo ports 16 and two ⅛″ female stereo ports 17 along with a switch to change from a stereo signal to mono signal 18, and another switch to mute and unmute audio signals 19.

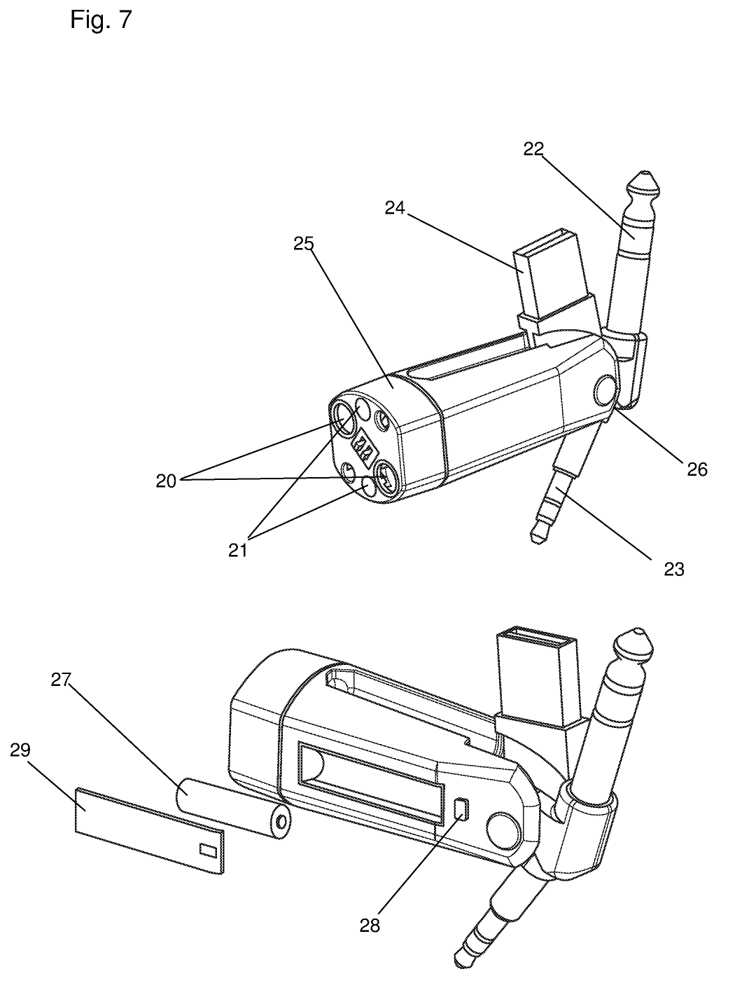

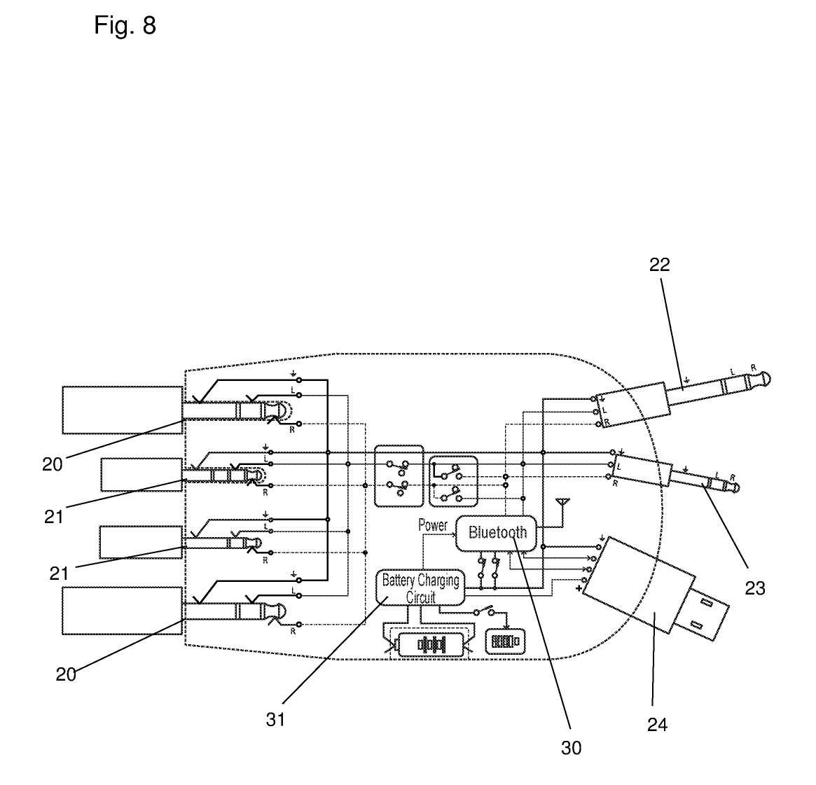

FIG. 7 and FIG. 8 illustrate a view of the Multi-use Connector showing in the configuration, a wired and wireless, dual size, quadruple input female to male headphone stereo audio adapter. Shown are various features like two ¼″ female stereo audio input 20 and two ⅛″ female stereo audio input 21 on the back side, one ¼″ male stereo plug 22, one ⅛″ male stereo audio plug 23, and a regular size USB male connector 24, all connected to the main body 25 through a swivel like mechanism by a hinge 26, and on the body, a Bluetooth (invisible) switch to enable the pairing with another Bluetooth enabled Multi-use Connector, an internal removable and rechargeable battery 27, a battery check switch 28, and battery door 29.

FIG. 8 shows the circuit that illustrates how all the various terminals are connected.

FIG. 8 shows the two ¼″ female stereo audio input 20 and two ⅛″ female stereo audio input 21, one ¼″ male stereo plug 22, one ⅛″ male stereo audio plug 23, and a regular size USB male connector 24, a Bluetooth (invisible) switch 30 to enable the pairing with another Bluetooth enabled Multi-use Connector, and battery charging circuit 31.

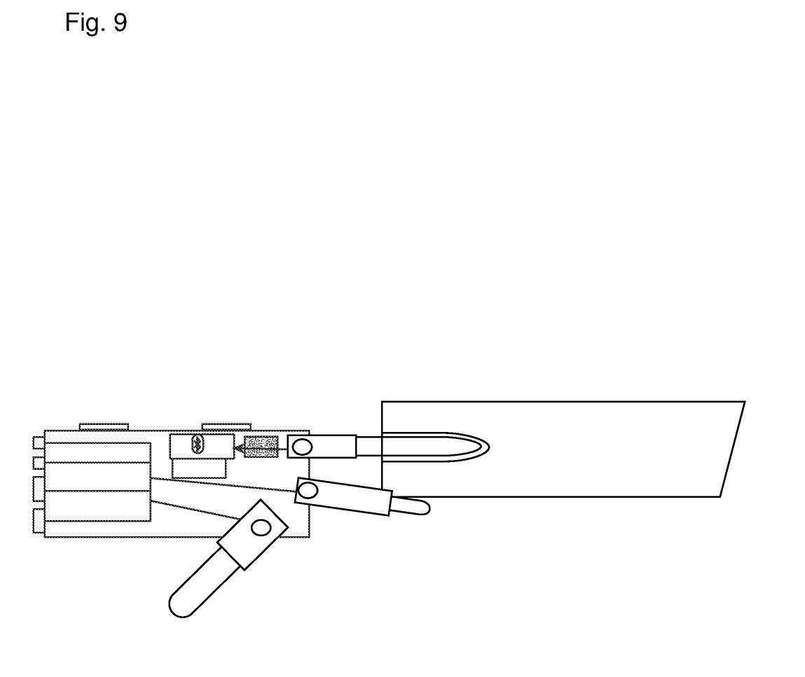

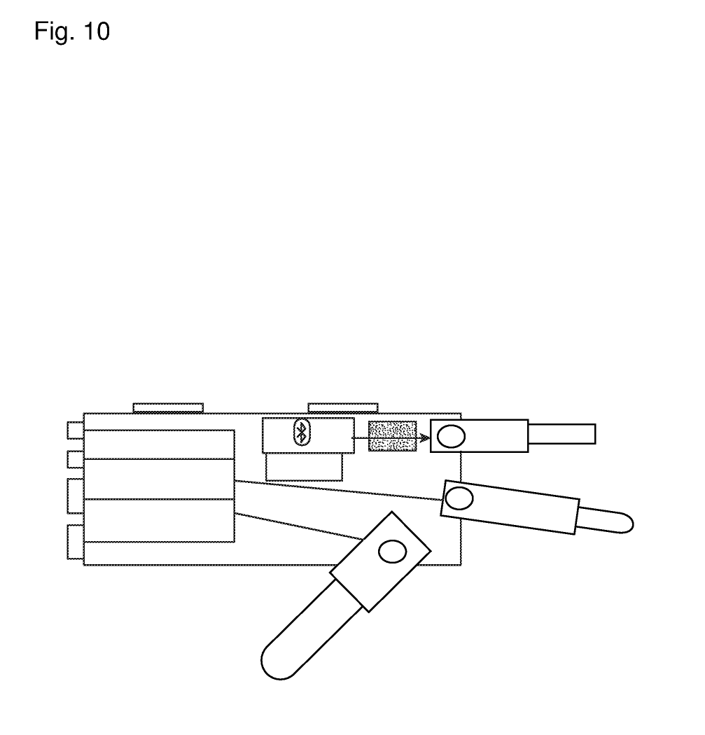

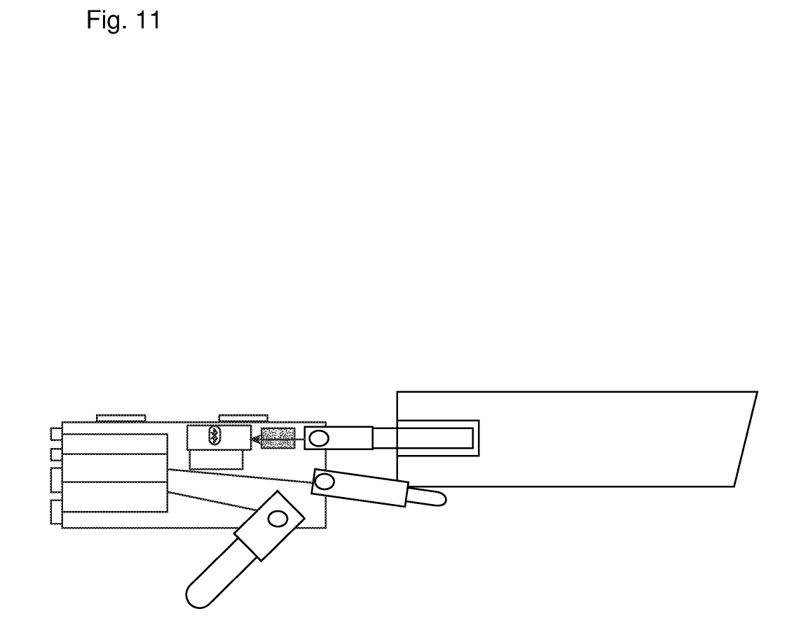

FIG. 9 through FIG. 11 illustrates that the Multi-use Connector has a circuit inside that can convert analog audio to digital for further wireless transmission when it is put in a “send” mode, or convert wirelessly received digital audio to analog audio when it is set in a “receive” mode.

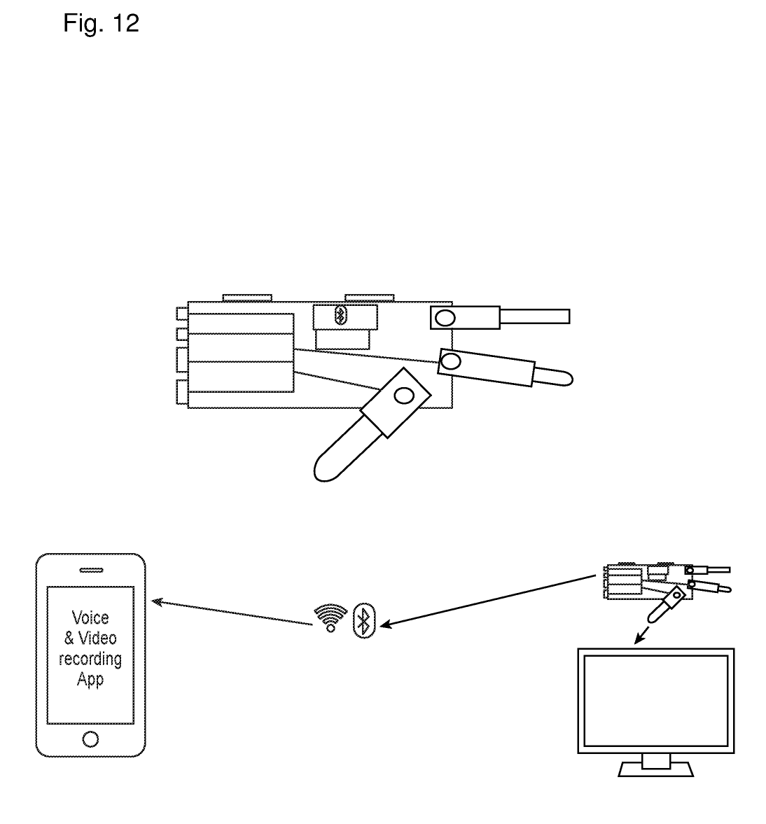

FIG. 12 illustrates a view of the Multi-use Connector showing in a user configuration of a “Wired and Wireless, Dual size, Quadruple input female to male Headphone stereo audio adapter,” with a “Voice, wireless audio & video recording app”.

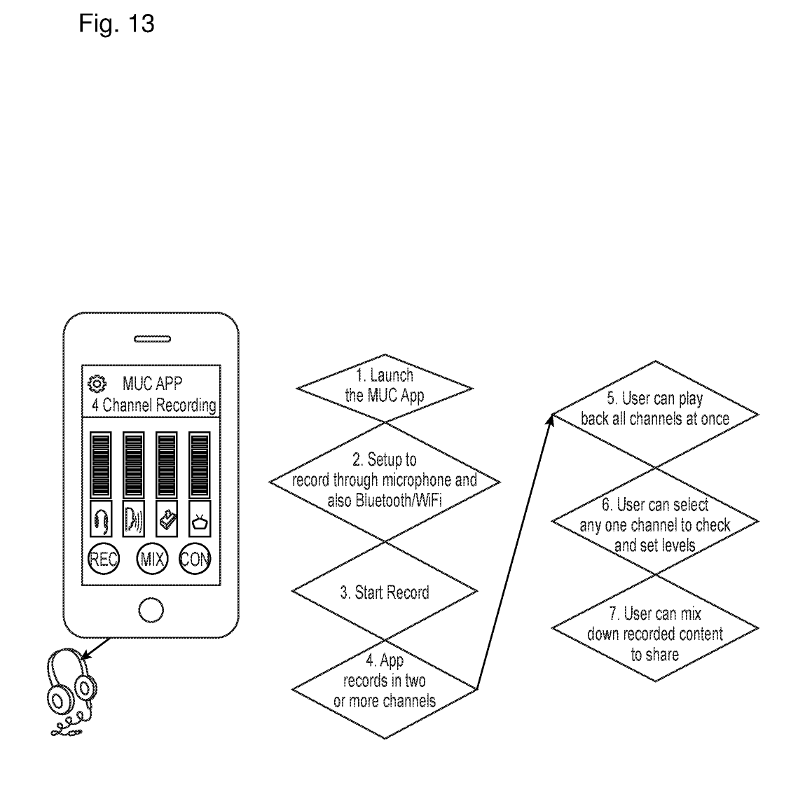

FIG. 13 illustrate a view of the Multi-use Connector showing in the configuration of a Software Application that supports recording of both wireless audio and or video signals coming through a wireless transmitter like the Multi-use Connector and simultaneously recording over-the-air audio signals through a smartphone's microphone in two or more separate channels.

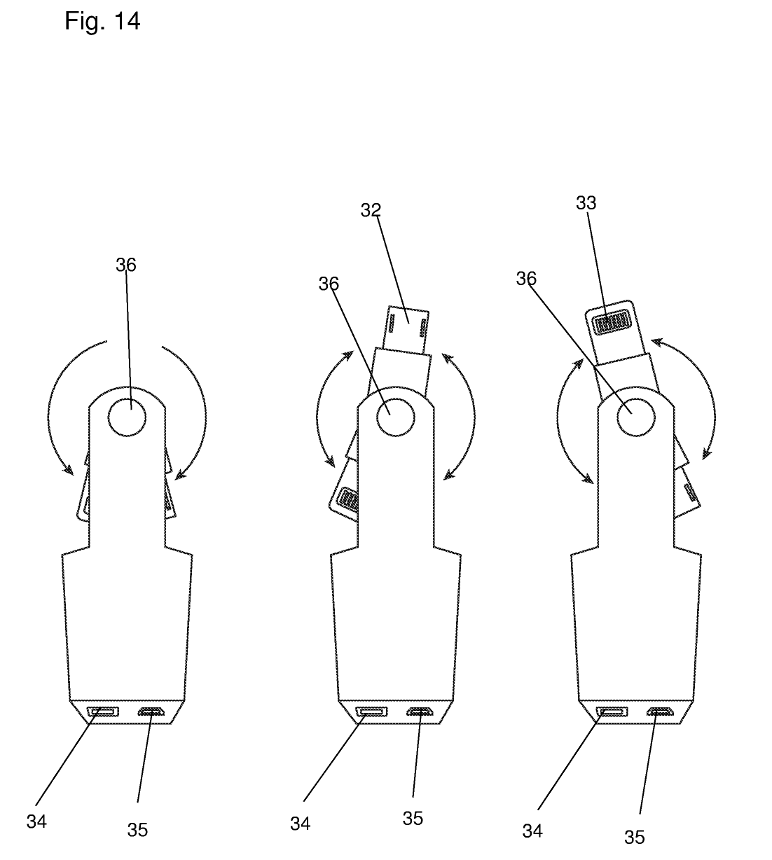

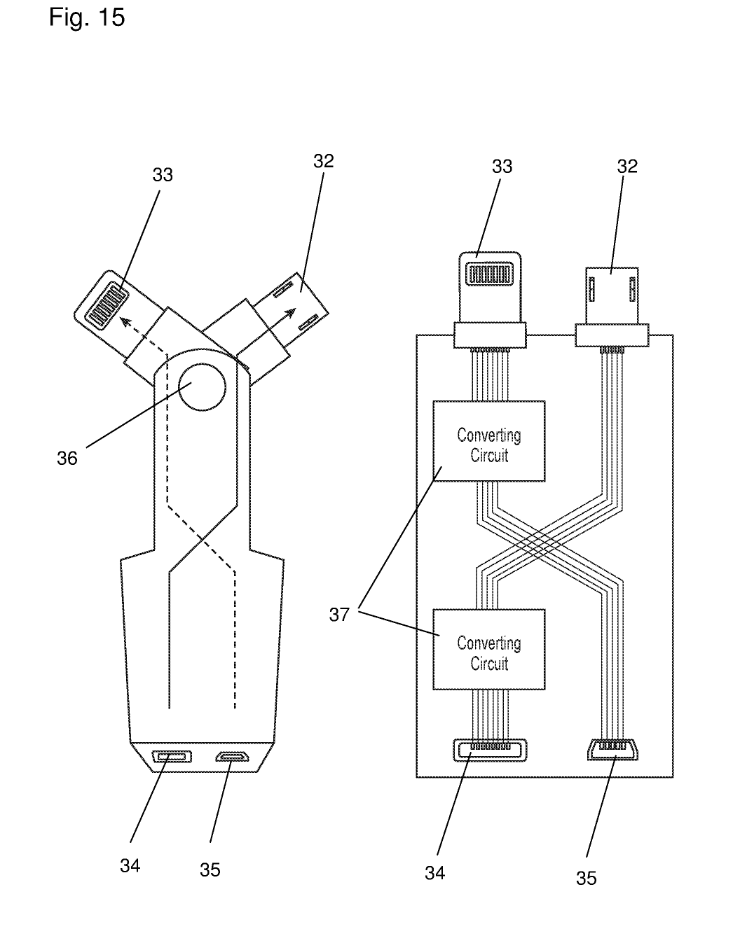

FIG. 14 and FIG. 15 illustrates a view of the Multi-use Connector showing in the configuration of a “Dual Charger plug converter.” This configuration is mainly used for electrically charging mobile devices like smartphones of various types that have different styles of charging ports. If a user does not have the right charger plug for a said device, this charger can be used to cross connect and charge as it has two different styles of inputs and outputs. Shown are features like a micro USB male connector 32, a Lighting male plug 33 (by Apple, Inc.), and a Female lighting connector at the backside or the other end 34, and a micro USB female input 35. These various style inputs and outputs are cross connected through a converter circuit 37. The two different males are connected to the unit by a swivel mechanism by a hinge 36.

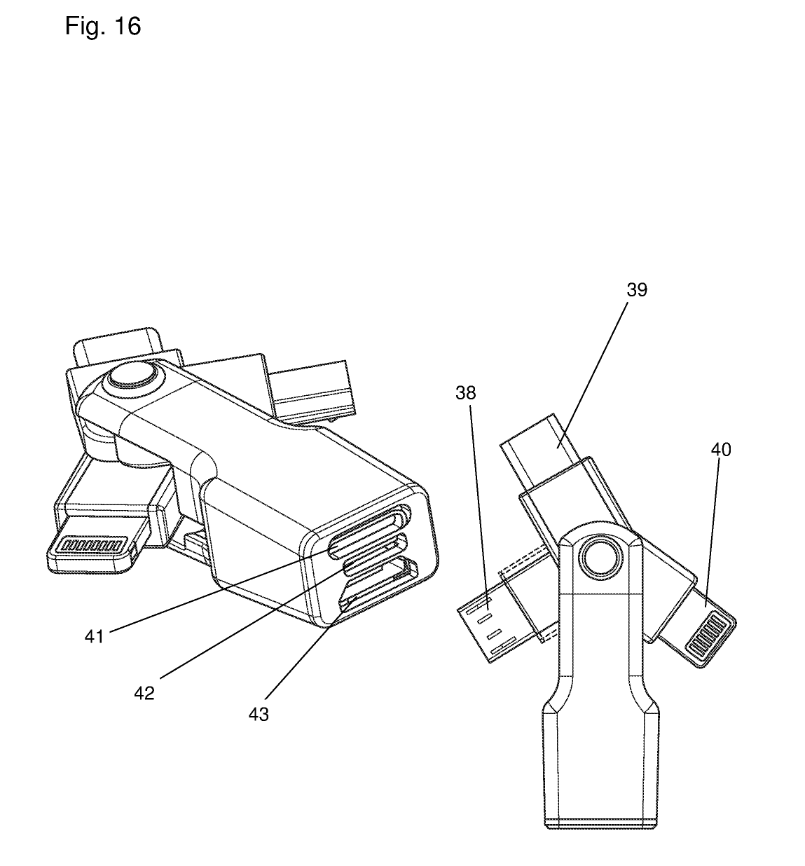

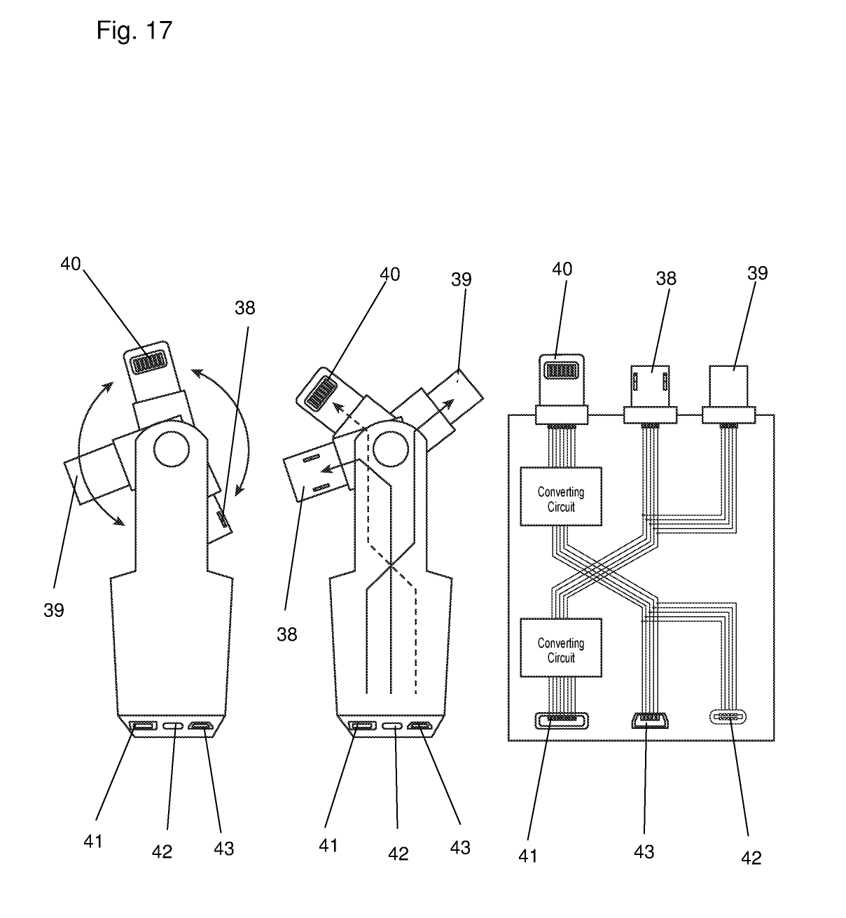

FIG. 16 and FIG. 17 illustrate a view of the Multi-use Connector showing in the configuration of a “Triple Charger plug converter.” Shown are various features like: a Micro USB male Type C connector 38, a Micro USB male connector 39, a Lightning male connector 40, a female Lighting input port 41, a Micro USB female port 42, and a Micro USB Type C female port 43, and in FIG. 17, a circuit diagram that shows the interconnection of all the various elements mentioned here.

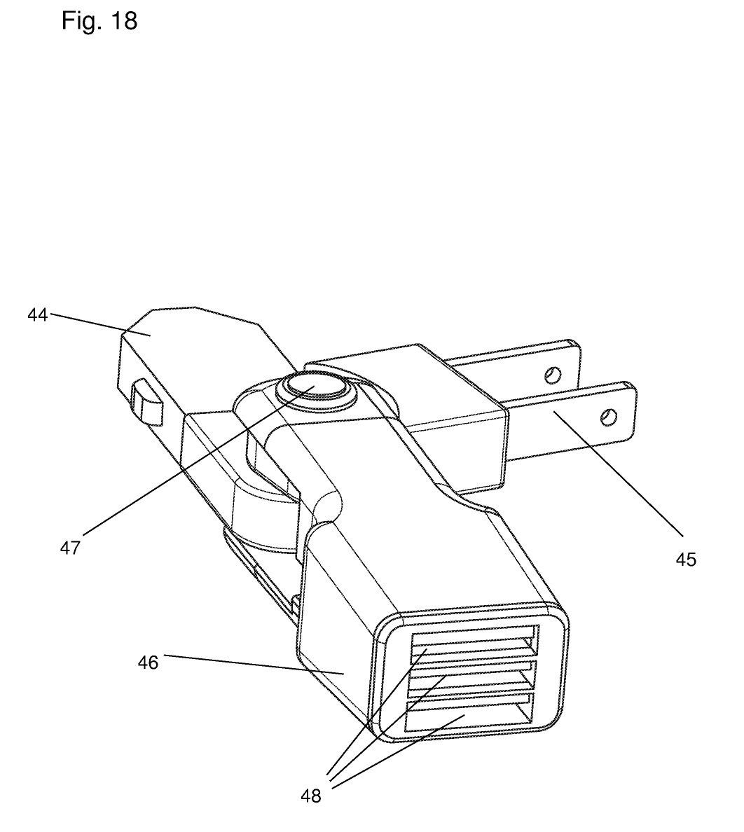

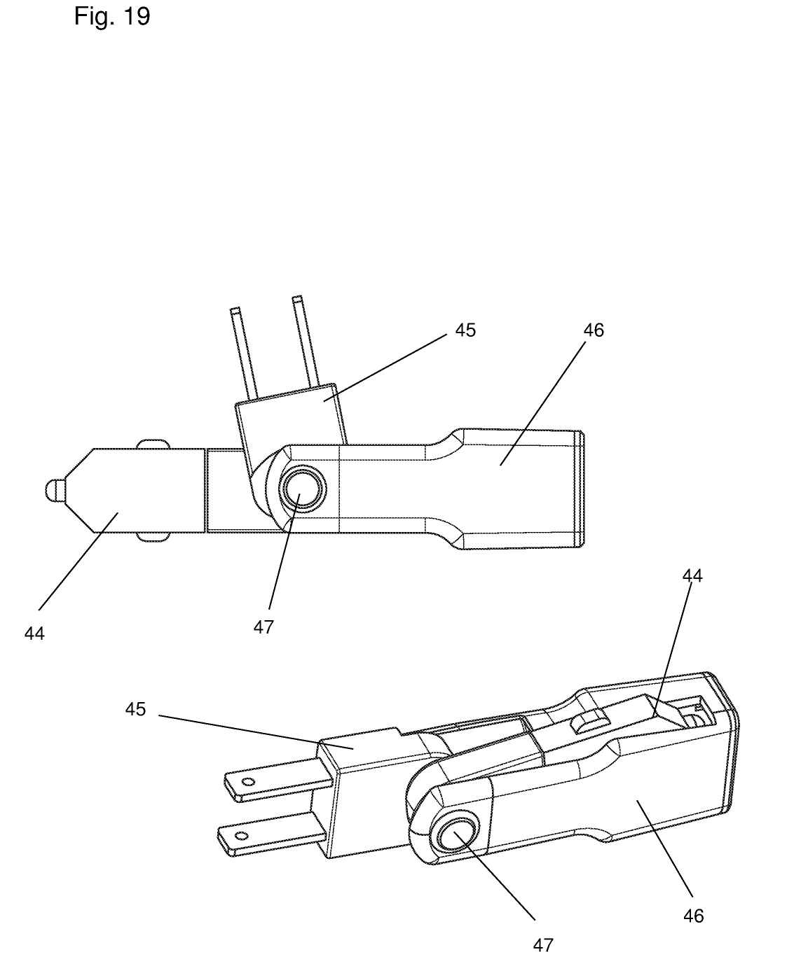

FIG. 18 illustrates a view of the Multi-use Connector showing in the configuration of an “AC/DC/USB Connector.” Shown are various features like a regular male USB connector, a DC connector 44, an AC male connector with auto switching between 220-120 volts 45, connected to the main body 46 by a swivel or pivot mechanism by a hinge 47 and on the back side three regular USB female ports 48. FIG. 19 show a cross view of the same configuration of FIG. 18 and a circuit diagram that shows the interconnection of all the various elements mentioned here.

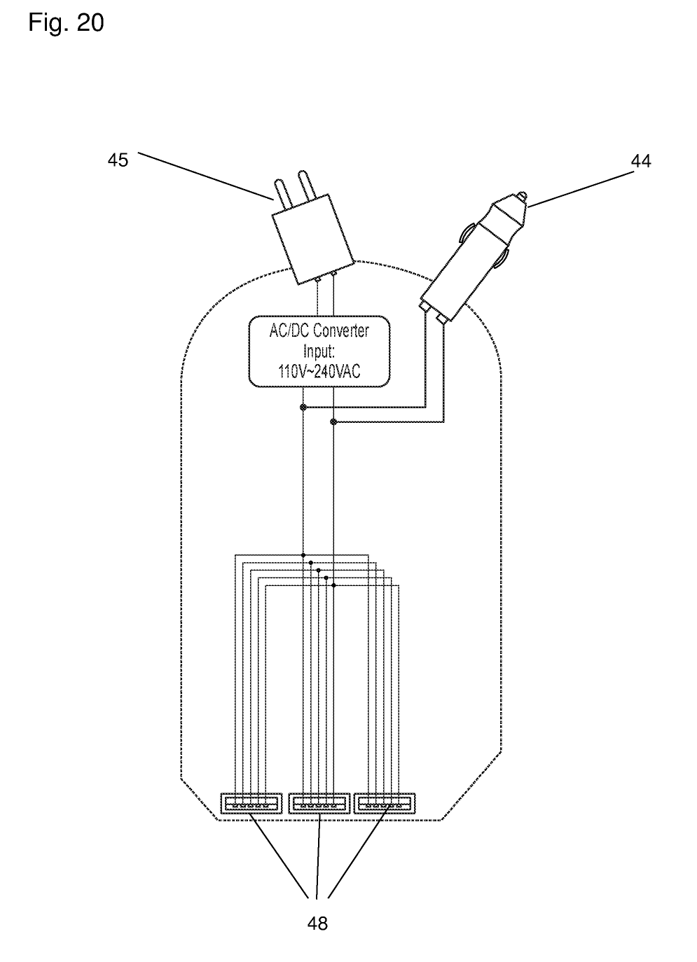

FIG. 20 shows a circuit diagram of the interconnection of all the various elements mentioned here.

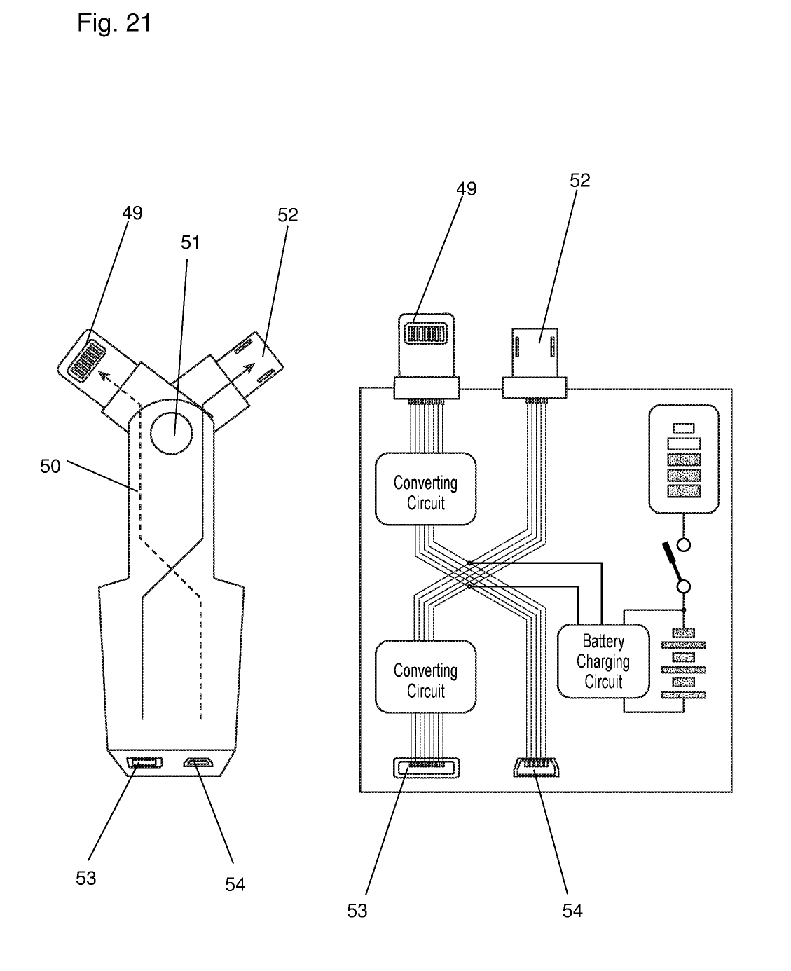

FIG. 21 illustrates a view of the MUC showing in the configuration of a “Backup charger and Dual Charger plug converter”. Shown are various features like a micro USB male connector, a Lightning male connector 49 on one side connected to the main body 50 by a swivel or pivot mechanism by a hinge 51, a female USB connector 52, a female Lightning connector port 53, a Micro USB female port 54, a rechargeable and removable battery to charge a target mobile device, and a battery ON and OFF switch that controls powering the target mobile device.

1. A multi-use connector comprising:
at least one style or size female port for audio or electrical charge transmission;
at least one other style or size female port for audio or electrical charge transmission;
at least one style or size of male plug for audio or electrical charge transmission;
at least one other style or size of male plug for audio or electrical charge transmission;
at least one style of male plug connected to the main body on one side through pivot style or swivel style mechanism;
at least one other style male plug connected to the main body on one side through pivot style or swivel style mechanism;
when one male plug is being used, the other male plug rests in the main body in a slot,
a circuit inside the body that interconnects all the female and male terminals so that it is possible to connect to any one terminal and the signal, whether it is audio or electrical or data is transmittable to any other port or terminal, thus making it possible to adapt from one style of port to any other type of port or plug that can be connected to any mobile device;
further, all input ports can be connected at the same time as needed and appropriate, and all output ports or plugs can be connected at the same time for use as needed and appropriate.

2. A multi-use connector of claim 1, wherein there is a switch to change an audio signal from a three pin to a four pin configuration and back, another switch to change an audio signal from a stereo signal to a mono signal and back, and another switch to mute or unmute the audio signal, or further manipulate the audio, electrical or data signals as maybe desired, these features are not meant to be a limitation in this type of invention but meant to be a demonstration.

3. A multi-use connector of claim 1, wherein there are two female inputs of one size and two female inputs of another size, with one male size and another a bigger male size for audio interconnection.

4. A multi-use connector of claim 1, claim 2, and claim 3, all these claims together or claim 1 independently with the claim 4 has at least one male USB plug that can be used for charging and or for audio or video or data connection from a target device, and a rechargeable and removable battery for powering the present invention and corresponding circuitry to enable such.

5. A multi-use connector of claim 1 through 4, and also as an independent claim, wherein there is a Bluetooth or any wireless transmitter system for audio or video signal transmission or reception as maybe decided by a user through the activation of the corresponding buttons or commands to either send or receive the wireless digital signals, and another mechanism to convert analog signals to digital audio signals, the signals coming from a headphone port of instruments like a music keyboard (when the Multi-use Connector is connected by its male stereo plugs to such devices), and also a mechanism to convert wirelessly received digital audio signals into analog which then can be transmitted to the various terminals of the present invention like the male stereo plugs for further use in devices that accept analog sound signals, a feature or system that will enable wired and or wireless transmission of audio, video or data from one device with another similar device and or a software application installed on a smartphone like device, a switch to enable pairing to another similar device, a switch to check battery power etc.

6. A multi-user connector of claim 1, claim 3 and claim 4, where the connector works both by regular wired connection and a wireless connection at the same time.

7. A multi-use connector of claim 1, and also as an independent software claim wherein a software application running on a computer like device or a smartphone device, that is capable of detecting and recording wireless audio or video signals from a Multi-use Connector that may be connected to a musical keyboard for example, and also be able to detect audio through the microphone of the software application's hosting device, simultaneously, and record both signals in different channels of the voice and video recording application whether it is running on a smartphone, or another computer like device that has multimedia capabilities.

8. A multi-use connector of claim 1, and also as an independent claim, wherein there is one type of male like a Micro USB plug, and another style of male plug like a Lightning plug made by Apple, Inc. and cross connected to a corresponding female Micro USB Port on the other side of the main body, and also to another style of female port like the Lightning port made by Apple, Inc., and the male plugs connected to the main body through a swivel style mechanism so that when one male plug is not used, it can be folded down to rest in a designated slot in the body of the multi-use connector.

9. A multi-use connector of claim 1, wherein there are two or more regular sized female USB ports on one side, there is a DC male connector, there is also a male AC plug within which there is auto switching between 220v and 120v connected to the main body by swivel or pivot style mechanism.

10. A multi-use connector of claims 1 and 7 wherein there is also a rechargeable and removable battery inside (and a corresponding circuitry to enable such) that can be charged when it is connected to a power source, and the multi-use connector can itself charge a target mobile device by the inbuilt battery as needed by a user even when disconnected from an active power source like an AC or DC outlet, there is also an ON and OFF switch to allow it to charge a connected mobile device.
